(19) United States
(12) Patent Application Publication
(10) Pub. No.: US 2020/0049348 A1
(43) Pub. Date: Feb. 13, 2020

(54) ARRANGEMENT FOR CONTROLLING A FLAME OF A CANDLE

(71) Applicant: NIRVANA CANDLE LLC, Troy, MI (US)

(72) Inventors: Stephen BUTLER, Troy, MI (US); Michael SULLY, Troy, MI (US)

(73) Assignee: NIRVANA CANDLE LLC, Troy, MI (US)

(21) Appl. No.: 16/535,546

(22) Filed: Aug. 8, 2019

Related U.S. Application Data
(60) Provisional application No. 62/718,003, filed on Aug. 13, 2018.

(51) Int. Cl. F23Q 25/00; F21V 35/00; B65D 43/26

(52) U.S. Cl. CPC F23Q 25/00; B65D 43/26; F21V 35/00

(57) ABSTRACT

An arrangement for controlling a flame of a candle includes a lid mounted to the jar of the jar candle for articulation between an open position and a closed position. The arrangement further includes an electromagnet, a permanent magnet and a power source. The electromagnet is carried in a housing fixed to the jar. The permanent magnet is carried by the lid. The power source provides powering the electromagnet. The electromagnet cooperates with the permanent magnet to retain the lid in the open position when the power source powers the electromagnet and allow the lid to articulate to the closed position when the power source is disconnected from the electromagnet.

### CROSS-REFERENCE TO RELATED APPLICATION

This application claims the benefit of U.S. Provisional Patent Application No. 62/718,003 filed 13 Aug. 2018, which application is herein expressly incorporated by reference.

### FIELD

The present teachings generally relate to candles. More particularly, the present teachings relate to jar candles. Even more particularly, the present teachings relate to an arrangement for controlling a flame of a candle.

### BACKGROUND

Candles are common used in homes for a variety of reasons, including bringing a pleasant aroma to a room, setting a mood, elimination of odor, or simply as a warm light.

One type of candle commonly used in homes is referred to as a jar candle. A jar candle generally includes a wax (paraffin/soy/beeswax/etc.) and wick(s) combination inside of a glass jar. Jar candles advantageously contain the wax, and ensure that the melted wax stays within a predetermined space. These jar candles, however, do not eliminate the risk of a neglected flame. A seemingly infinite number of dangerous scenarios can occur when a flame is left unattended for an extended period of time. For example, the jar may be knocked over by a child or animal, the candle may burn down to the bottom and crack the glass, or an object may come too close to the flame, causing ignition. The most efficient way to limit the seemingly endless risks of a neglected flame is to simply limit the amount of time the flame is neglected. For example, a jar candle may potentially burn neglected for eight or more hours if the user falls asleep. By automatically extinguishing the flame after an hour or two, the risk is significantly reduced.

To a limited extent, arrangements have been proposed for extinguishing the flame of a candle. An example of such an arrangement is shown in U.S. Pat. Nos. 8,029,272. 8,029,272, describes a self-activated automatic candle snuffer. The device generally includes a back plate connected to a base and to a spoon having a hole so that the back plate supports the spoon for spring movement with respect to the base. A candle is mounted to the base such that the candle passes through the hole in the spoon. A set pin is movably affixed to the spoon proximate the hole and is operatively arranged to pierce and enter the candle so as to maintain tension in the spoon. A ball is balanced on the spoon and means is provided for releasing tension in the spoon to causes release of potential energy that allows the spoon to elevate to an inclined plane to cause the ball to roll down the spoon to settle on the hole and the wick and extinguish a flame.

While some arrangements for controlling a flame of a candle have been proposed, a need for continuous improvement in the art remains.

### SUMMARY

In accordance with one aspect, the present teachings provide an arrangement for controlling a flame of a jar candle. The arrangement includes a lid mounted to the jar of the jar candle for articulation between an open position and a closed position. The arrangement further includes an electromagnet, a permanent magnet and a power source. The electromagnet is carried in a housing fixed to the jar. The permanent magnet is carried by the lid. The power source provides powering to the electromagnet. The electromagnet cooperates with the permanent magnet to retain the lid in the open position when the power source powers the electromagnet and allow the lid to articulate to the closed position when the power source is disconnected from the electromagnet.

In accordance with another aspect, the present teachings provide method for controlling a flame of a jar candle. The jar candle includes a lid mounted to the jar of the jar candle for articulation between an open position and a closed position. The method includes fixing an electromagnet relative to the jar. The method additionally includes mounting a permanent magnet to the lid. The method further includes powering the electromagnet with a power source such that the electromagnet and the permanent magnet cooperate to retain the lid in the open position when the power source powers the electromagnet and allow the lid to articulate to the closed position when the power source is disconnected from the electromagnet.

Further areas of applicability will become apparent from the description provided herein. It should be understood that the description and specific examples are intended for purposes of illustration only and are not intended to limit the scope of the present disclosure.

### DRAWINGS

The present teachings will become more fully understood from the detailed description, the appended claims and the following drawings.

FIG. 1 is perspective view of a top view of an arrangement for controlling a flame of a candle, the arrangement shown operatively associated with a jar candle and a lid of the arrangement shown articulated to an open position.

FIG. 2 is a side view of the arrangement for controlling a flame of a candle and jar candle of FIG. 1.

FIG. 3 is a perspective view similar to FIG. 1 with the lid of the arrangement shown articulated to a closed position.

FIG. 4 is a side view similar to FIG. 2 with the lid of the arrangement shown articulated to a closed position.

FIG. 5 is an exploded view of the arrangement for controlling a flame of a candle in accordance with the present teachings.

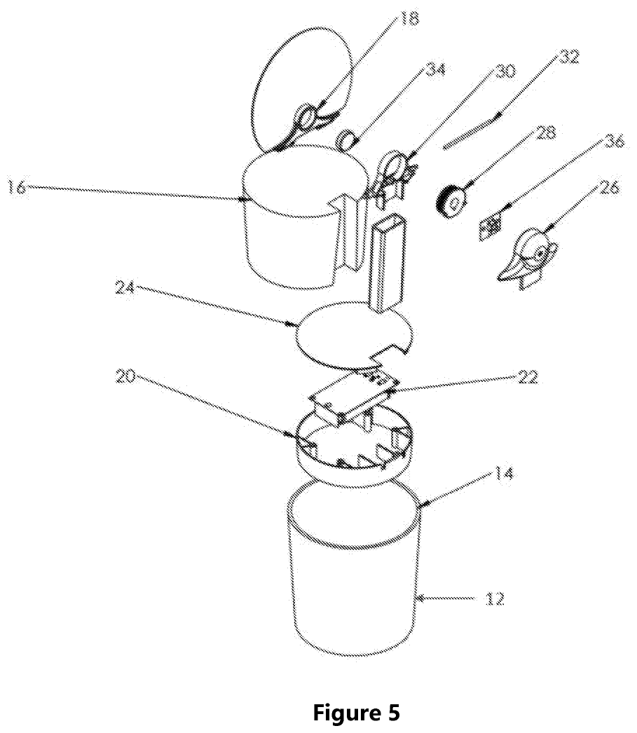

### DESCRIPTION OF VARIOUS ASPECTS

The following description is merely exemplary in nature and is not intended to limit the present disclosure, application, or uses. It should be understood that throughout the drawings, corresponding reference numerals indicate like or corresponding parts and features. The description and any specific examples, while indicating embodiments of the present disclosure, are intended for purposes of illustration only and are not intended to limit the scope of the present disclosure.

With general reference to the drawings, an arrangement for controlling a flame of a candle in accordance with the present teachings is illustrated and generally identified at reference character 10. The arrangement 10 is shown throughout the drawings operatively associated with a jar candle 12. The particular candle 12 shown in the drawings will be understood to be exemplary. In this regard, it is anticipated that the present teachings may be readily adapted for use with various other candles.

Before turning to the arrangement 10 of the present teachings, a brief description of the jar candle 12 is warranted. The jar candle 12 is shown to conventionally include a jar 14 and a candle 16. The candle 16 may be placed within the jar 14 or the wax of the candle 16 may be poured directly into the jar 14. It will be understood that the particular jar candle 16 shown in the drawings is merely exemplary. In this regard, the present teachings may be readily adapted for various other jar candles 12 within the scope of the present teachings.

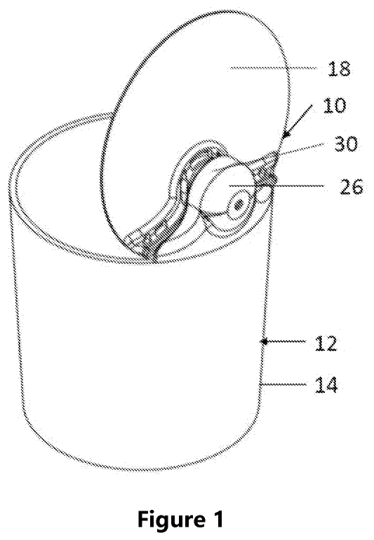

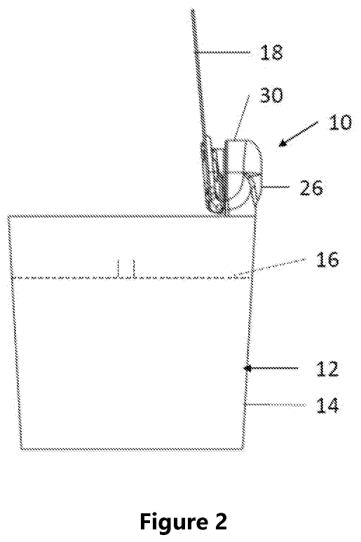

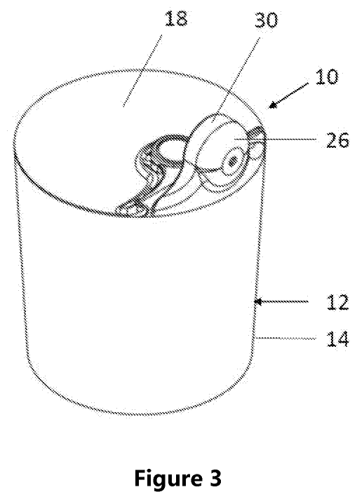

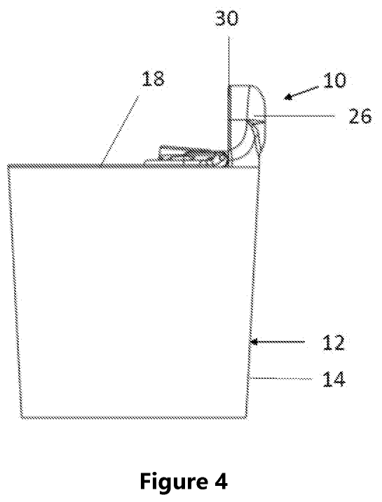

A lid 18 is mounted to the jar 14 for movement between an open position and a closed position. In this regard, the lid 18 may be coupled to the jar 14 through a hinge. The open position of the lid 18 is shown in FIGS. 1 and 2. The closed position of the lid 18 is shown in FIGS. 3 and 4.

In addition to the lid 18, the arrangement 10 of the present teachings for controlling a flame of the candle 12 is generally shown to include a bottom battery housing 20, a timing device 22, a top battery housing 24, a back electromagnet housing 26, an electromagnet 28, a front electromagnet housing 30, a metal rod 32, and a permanent magnet 34.

In the particular embodiment illustrated, the bottom battery housing 20 is designed to hold a power source for powering the electromagnet 28. In one particular embodiment, the power source may comprise two AA batteries. The housing 20 may also include the timing device 22. The timing device operates to control power from the power source to the electromagnet 28 and may comprise a printed circuit board 22. This printed circuit board 22 may be mounted on the housing 20 so it does not move during transport. The printed circuit board 22 may utilize a nanotimer in order to control the duration of the electromagnetic activity. One suitable nanotimer is available from Texas Instruments as part number TI5111.

The top battery housing 24 covers the bottom battery housing 20, mentioned above. The top battery housing 24 contains a small indentation in which a hollow metal tube is inserted. This metal tube connects the top battery housing 24 to the electromagnet housing 26 and 30. The wires from the electromagnet 28 run through this hallow metal tube and connect to the timing device 22.

The back electromagnet housing 26 may be snapped together with the front electromagnet housing 30 and houses the electromagnet 28. The back electromagnet housing 26 also mounts the push button switch 36 used by the end user to indicate when they wish to light the candle 16.

In one application, the electromagnet 28 may simply be a very thin copper wire wrapped many times around a bobbin. The copper wire may be self-adhering and may hold the shape of a bobbin without the need for a bobbin housing. The electromagnet 28 may be designed to maximize the magnetic field for the given power constraints. In one embodiment, the electromagnet 28 may use AWG (American Wire Gauge) 36 wire—wrapped 1000+ times around the bobbin to produce a sufficient magnetic field while ensuring enough resistance so the batteries will last throughout the life of the candle 16. The insulation has been peeled off of the beginning of the wire and the end of the wire in order to connect the electromagnet 28 to the printed circuit board 22 and complete the circuit.

The metal rod 32 is placed through holes in the lid 18 and the front electromagnet housing 30 to create the hinge coupling the lid 18 to the jar 14. The lid 18 rotates about an axis defined by the metal rod 32. The permanent magnet 34 and the electromagnet 28 are cooperatively position to allow the permanent magnet 34 to be aligned with the electromagnet 28 when the lid 18 is in the open position.

The front electromagnet housing 30 is snapped together with the back electromagnet housing 26 and houses the electromagnet 28. In addition, the front electromagnet housing 30 contains an area which the metal rod 32 is placed through to create a hinge with the lid 18. The electromagnet 28 has been placed inside of the circular area of the front electromagnet housing 30, aligning the bobbin with one side of this housing such that when the lid is open, it is able to make direct contact with the electromagnet 28.

Due to the weak nature of the electromagnet 28, a permanent magnet 34 is secured to the lid 18 through use of an adhesive, for example. The magnet/electromagnet combination of the present teachings has sufficient magnetic force to hold the lid 18 open at normal operating temperatures, but the thermal properties of the permanent magnet 34 ensures that the lid 18 will close if the lid 18 begins to hit unsafe temperatures.

As illustrated, the lid 18 of the present teachings is constructed of a high-temperature resistant material molded to house the permanent magnet 34. The lid 18 also includes a hinge, thus allowing the lid to rotate upon an axis with respect to the front electromagnet housing 30.

In operation, when the end user presses a button on the back electromagnet housing 26, the electromagnet 28 is powered on. The end user lifts the hinged lid 18 upwards to a near vertical position, until it is pressed against the electromagnet 28. As used herein, the term “near vertical” will be understood to mean that the lid 18 will normally close under the force of gravity. A permanent magnet 34 is needed on the lid 18 to create an attractive force large enough that the lid will stay in the open position when the electromagnet 28 is on. The electromagnet 28 holds the lid 18 in the open position, and the end user then lights the candle 16. The electromagnet 28 is hooked up to a timing device 22, located in the bottom battery housing 20. This timing device 22 cuts the power to the electromagnet 28 after a predetermined time period. After the predetermined time period, the permanent magnet 34 is no longer being attracted to the electromagnet 28. Since the lid 18 is slightly off vertical, gravity closes the lid 18 following demagnetization of the electromagnet 28. When the lid 18 is closed, it cuts off the oxygen flowing to the candle 16 flame, resulting in the flame being extinguished.

It will now be appreciated that the present teachings provide an arrangement for a jar candle 12 which increases safety and otherwise reduces worry by limiting the maximum amount of time a candle can potentially be neglected.

While a specific example and use has been described in the specification and illustrated in the drawings, it will be understood by those skilled in the art that various changes may be made and equivalence may be substituted for elements thereof without departing from the scope of the present teachings as defined in the claims. Furthermore, the mixing and matching of features, elements and/or functions between various examples may be expressly contemplated herein so that one skilled in the art would appreciate from the present teachings that features, elements and/or functions of one example may be incorporated into another example as appropriate, unless described otherwise above. Moreover, many modifications may be made to adapt a particular situation or material to the present teachings without departing from the essential scope thereof. Therefore, it may be intended that the present teachings not be limited to the particular examples illustrated by the drawings and described in the specification as the best mode of presently contemplated for carrying out the present teachings but that the scope of the present disclosure will include any embodiments following within the foregoing description and any appended claims.

What is claimed is:

1. An arrangement for controlling a flame of a jar candle, the arrangement comprising:
a lid mounted to the jar of the jar candle for articulation between an open position and a closed position;
an electromagnet carried in a housing fixed to the jar;
a permanent magnet carried by the lid; and
a power source for powering the electromagnet,
wherein the electromagnet cooperates with the permanent magnet to retain the lid in the open position when the power source powers the electromagnet and allow the lid to articulate to the closed position when the power source is disconnected from the electromagnet.

2. The arrangement for controlling a flame of a candle of claim 1, further comprising a timing device for disconnecting the power source from the electromagnet after a period of time.

3. A method of controlling a flame of a jar candle, the jar candle including a lid mounted to the jar of the jar candle for articulation between an open position and a closed position, the method comprising:
fixing an electromagnet relative to the jar;
mounting a permanent magnet to the lid; and
powering the electromagnet with a power source such that the electromagnet and the permanent magnet cooperate to retain the lid in the open position when the power source powers the electromagnet and allow the lid to articulate to the closed position when the power source is disconnected from the electromagnet.

4. The method of controlling a flame of a candle of claim 4, further comprising controlling the power source with a timing device to disconnect the power source from the electromagnet after a period of time.
